(19) United States
(12) Patent Application Publication
(10) Pub. No.: US 2005/0230526 A1
(43) Pub. Date: Oct. 20, 2005

(54) Lighter-than-air aircraft comprising several balloons linked by a chassis

(75) Inventors: Christophe Loustaudaudine, Areines (FR); Pascal Le Roux, Tregastel (FR)

Correspondence Address: SHEWCHUK IP SERVICES, 533 77TH STREET WEST, EAGAN, MN, 55121, US

(73) Assignees: Christophe Loustaudaudine, Areines (FR); Pascal Le Roux, Tregastel (FR); Christophe Bertholet, La Freite sur Seine (FR); Anne Marchegay, Paris (FR)

(21) Appl. No.: 10/518,068

(22) PCT Filed: Jun. 26, 2003
(86) PCT No.: PCT/FR03/01983

§ 371 Date: Jun. 16, 2005

(30) Foreign Application Priority Data
Jun. 27, 2002 (FR) 02/08045
Jul. 25, 2002 (FR) 02/09469

(51) Int. Cl. B64B 1/06

(52) U.S. Cl. 244/29

(57) ABSTRACT

The invention concerns the field of aeronautics. More precisely, the invention concerns a lighter-than-air aircraft. The invention is characterized in that the aircraft comprises two balloons (1) mutually linked by linking means forming a chassis (2).

The invention relates to aeronautics. More precisely, the invention relates to an aircraft lighter than air.

Essentially two different types of aircraft lighter than air are known in the domain of the invention, namely airships and hot air balloons.

The principle of airships is to use a generally rigid envelope filled with a gas lighter than air, a cab for transporting passengers and/or goods being anchored under the envelope or close to it.

Hot air balloons use flexible envelopes inflated with hot air through an opening provided for this purpose, a gondola being attached by cables under the envelope.

The envelopes of these aircraft are very large which make the aircraft very difficult to manoeuvre. Furthermore, airships and hot air balloons have a very large face to the wind. Therefore, this can cause navigation difficulties, or even unacceptable safety, both for transported persons or goods, and for persons or installations on the ground if the airship or the hot air balloon should crash.

These navigation difficulties are accentuated by the very structure of airships and more particularly hot air balloons, for which the envelope/gondola (or cabin) arrangement can form a pendulum system, capable of introducing swinging movements that are difficult to control.

There is also a major risk inherent to the principle of lighter than air aircraft: the risk of a tear or other damage to the envelope that will cause loss of the lighter than air gas contained in the envelope, therefore a slow or fast descent of the airship or the hot air balloon possibly with dramatic consequences.

To limit this risk, it has been proposed to break the envelopes down into several separate envelopes. In the state of the art, the lighter than air gas is contained in several balloons grouped within the same envelope, rather than in a single envelope. Thus, the loss of one balloon can be compensated by the presence of other balloons, maintaining the capacity of the airship or the hot air balloon to fly.

However, this solution does not help to solve the navigation and stability problems mentioned above.

Furthermore, it is observed that the number of applications of airships and hot air balloons is relatively limited, particularly due to their lack of manoeuvrability.

This invention is intended to overcome the disadvantages of prior art.

More precisely, the purpose of the invention is to propose a lighter than air aircraft that in particular is easier to manoeuvre than conventional solutions according to prior art.

To achieve this, the purpose of the invention is to provide such an aircraft that has a significantly lower face to the wind than traditional envelopes of airships and hot air balloons.

Another purpose of the invention is to supply such an aircraft that has good stability under all circumstances, and that is thus safer.

Another purpose of the invention is to supply such an aircraft that eliminates or at least considerably reduces risks of dropping due to a puncture of a balloon.

These objectives and others that will become clear later are achieved by the invention, which applies to a lighter than air aircraft characterised in that it comprises at least two balloons connected together by connecting means forming a chassis.

Therefore, the invention proposes an approach fundamentally different from the traditional approach to classical airships and hot air balloons.

The aircraft according to the invention has two or more balloons on each side of a chassis, the balloons not being grouped within the same envelope as is the case with the state of the art in which separate envelopes are used.

The result is that the distribution of balloons considerably reduces the face to the wind of the aircraft according to the invention, compared with an aircraft that has a single envelope with a volume equal to the sum of the volumes of the different balloons of an aircraft according to the invention.

Furthermore, the balloons distributed in this way make the aircraft very easy to manoeuvre.

Another advantage is that risks of falling due to a puncture of one of the balloons are eliminated, or at least reduced, due to the presence of the other balloons.

It should be noted that the chassis may be formed by one or several independent parts.

According to a first approach, the said connecting means are connected to the said balloons through an electromagnetic type connection.

The result is thus a flexible assembly between the balloons and the frame, preventing stresses that could be applied to it by balloons due to their sudden possibly opposing movements.

According to a second approach, the said connecting means are coupled to at least one of the said balloons through a mechanical connection articulated about at least one axis approximately parallel to the longitudinal axis of the said aircraft.

Similarly, as in the first embodiment, this type of means can relieve loads from the frame by allowing relative movement between the balloons and the frame.

In this case, the said balloon(s) on one side of the said connecting means are preferably connected to the said balloon(s) on the other side of the said connecting means by elastic means.

Means of this type make it possible to keep an approximately constant general configuration of the aircraft, at least when flight conditions make it possible, in other words in the absence of wind gusts that could make one or several balloons pivot with respect to the frame.

Furthermore, these elastic means form a sort of damper that can reduce the impact of pivoting of the balloons with respect to the frame.

According to one advantageous solution, the said frame includes carrying means designed to support equipment and/or at least one person. In this case, according to one preferred solution, the said carrying means are essentially within the volume lying between the said balloons.

This avoids conventional pendulum structures according to prior art. There is absolutely no need to provide a gondola or cabin underneath the balloons, which could cause or increase swinging movements that are difficult to control.

On the contrary, the useful load is located between the balloons.

This characteristic has many advantages in practice and particularly:
the aircraft can land using its balloons as shock absorbers, or can come down on the sea, and in this case the balloons act as floats;
the useful load and/or transported persons are protected laterally since the balloons act as airbags;
the general architecture enables a useful load located between the balloons to have a field of action above and below the aircraft; cameras (movie cameras, still cameras, etc.) can operate efficiently below or above the aircraft (which is impossible with airships or hot air balloons for which the envelope acts as an obstacle to taking pictures above the cabin or the gondola);
the general architecture means that propulsion means can be placed ideally at the centre of gravity of the aircraft to optimise its performances.

The said balloons and the said connecting means together form an essentially symmetric assembly.

The aircraft will thus have excellent aerodynamic qualities.

According to a first embodiment, the aircraft comprises a balloon on each side of the said connecting means.

According to a second embodiment, the aircraft comprises two balloons on each side of the said connecting means.

In this case, according to a first variant, the said balloons lie in an approximately horizontal plane.

In a second variant, the said two balloons on the same side of the said connecting means are placed one above the other.

Obviously, other embodiments could be envisaged without going outside the framework of the invention, particularly by varying the number and the relative positions of the balloons.

It should be noted that the balloons may have variable shapes and dimensions adapted to the duties of the aircraft and that, depending on needs, they may be replaced by different balloons between two missions, with different shapes and/or dimensions.

Advantageously, the aircraft comprises means of propulsion and/or controlling the stability of the said aircraft.

Therefore, propulsion may be of the electric or thermal type, or electric and thermal energy types can be used as a function of the missions of the aircraft.

In the case of thermal propulsion, the aircraft according to the invention enables fuel tanks to be placed close to the engine(s) around the centre of gravity of the aircraft, such that stability can be kept almost constant as fuel is consumed.

According to one advantageous solution, the said propulsion means comprise at least one first engine capable of producing a thrust along the longitudinal axis of the said aircraft and located at or close to the centre of gravity of the said aircraft.

As already mentioned, the aircraft performances can be optimised by thus the propulsion means in this way.

Advantageously, the aircraft comprises pitch control means. In this case, the said pitch control means preferably include at least two engines installed approximately on the longitudinal axis of the said aircraft, one forward from the centre of gravity of the said aircraft, and the other aft from gravity of the said aircraft.

Thus, by acting on the differential thrust between the two engines, the pitch of the aircraft can be modified in order to stabilise it.

Advantageously, the aircraft comprises roll control means. In this case, the said roll control means preferably comprise at least two engines installed on each side of the longitudinal axis of the said aircraft, in an approximately horizontal plane.

According to one preferred solution, the said roll control engines are mounted on an axis perpendicular to the longitudinal axis of the said aircraft and passing through the centre of gravity of the said aircraft or close to it.

In the same way as for the pitch means, the roll of the aircraft is varied by varying the differential thrust between the two engines, in order to stabilise the aircraft.

Advantageously, the said stability control means can act on the altitude of the said aircraft.

By appropriately varying the pitch control engines and the roll control engines, they can be made to simultaneously produce a thrust from the same horizontal plane and perpendicular to this plane, in order to control the altitude of the aircraft.

According to one advantageous solution, the said propulsion means also comprise a means of displacing the said aircraft laterally. In this case, the said lateral displacement means preferably comprise at least two lateral engines, capable of producing thrusts in opposite directions along a horizontal axis perpendicular to the longitudinal axis of the said aircraft and passing through or close to the centre of gravity of the said aircraft.

In this way, the aircraft can be displaced efficiently in its own plane and perpendicular to its longitudinal axis.

Therefore, this characteristic contributes to improving the manoeuvrability of the aircraft.

According to one advantageous solution, the aircraft comprises directional means.

In this case, the said directional means advantageously comprise at least one control surface and preferably at least one left control surface and at least one right control surface mounted at the aft of the said aircraft.

Advantageously, the aircraft comprises at least one vertical stabiliser. In this case, the aircraft advantageously comprises at least one control surface mounted on the said vertical stabiliser.

It should be noted that these control surfaces are used essentially when the aircraft is being propelled, in particular during phases is which the aircraft is being displaced along its longitudinal axis.

Advantageously, the said directional means comprise at least one orientation engine installed so as to produce at least a thrust transverse to the longitudinal axis of the said aircraft.

It will be noted that in this case the engine may be a jet engine, therefore capable of providing opposing thrusts depending on its rotation direction.

According to one preferred solution, the said directional means comprise at least two orientation engines mounted with respect to each other so as to produce thrusts in approximately opposite directions.

These orientation engines may be installed at any appropriate location on the chassis of the aircraft, away from the centre of gravity of the aircraft to optimise their action, for example being mounted at the aft part of the aircraft.

These directional means are useful essentially when the aircraft is in a stationary flight, and can be used as complements to the control surfaces during displacement phases along the longitudinal axis of the aircraft.

Advantageously, the aircraft comprises remote control means, with or without wire.

Consequently, the aircraft can perform missions in environments dangerous for man, and in this case the man who controls the aircraft remains at a distance from the area in which the aircraft is operating.

Preferably, the said balloons are approximately cylindrical in shape.

This type of balloon configuration gives good aerodynamic qualities.

They also enable a chassis length with a large useful surface area.

According to one advantageous solution, the aircraft comprises onboard means belonging to the following group:
picture taking means,
communication and/or telecommunication means;
sound pickup means;
meteorological data acquisition means;
radiation measurement means;
air analysis means;
geographic positioning means;
means of measuring the speed of objects on the ground and/or in the air and/or at sea.

These means, possibly combined, enable the aircraft to perform a large number of diverse missions, particularly including:
shooting of films or broadcasting of television events (sports, special events, etc.);
promotion of a tourist site, a brand, etc.;
actions following a nuclear accident (map of radiations, relaying of communications for working robots on the ground);
analysis and sampling of ambient air following atmospheric pollution at different altitudes and positions to make a dynamic map (propagation) of the pollution;
telecommunication relay (HF, GSM and other systems);
listening and/or recording and/or retransmission of sound from the ground (search for missing persons, etc.) or airways surrounding the aircraft;
flying radar missions with prolonged stationary capabilities;
local interference of communications with prolonged stationary capabilities;
acquisition of meteorological information at different altitudes;
detection of initiating fire, with onboard temperature detection sensors (IR camera, temperature sensor, etc.);
visual monitoring;
monitoring of floods;
monitoring at sea (detection of oil dumping at sea, traffic management);
pipeline surveillance;
surveillance of high industrial risk and other sites;
surveillance of forests and agricultural regions;
motorway surveillance by integration of standard and/or IR cameras and laser type speed control radar;
transport of goods with loading and unloading facilities related to the shape of the aircraft;
monitoring of obstacles from remote sensors (above, below, at left or at right) for monitoring bridges or historic sites;
precise positioning from remote sensor to reposition itself at the same location and to make information measurements that can vary with time, at a precise and known point.

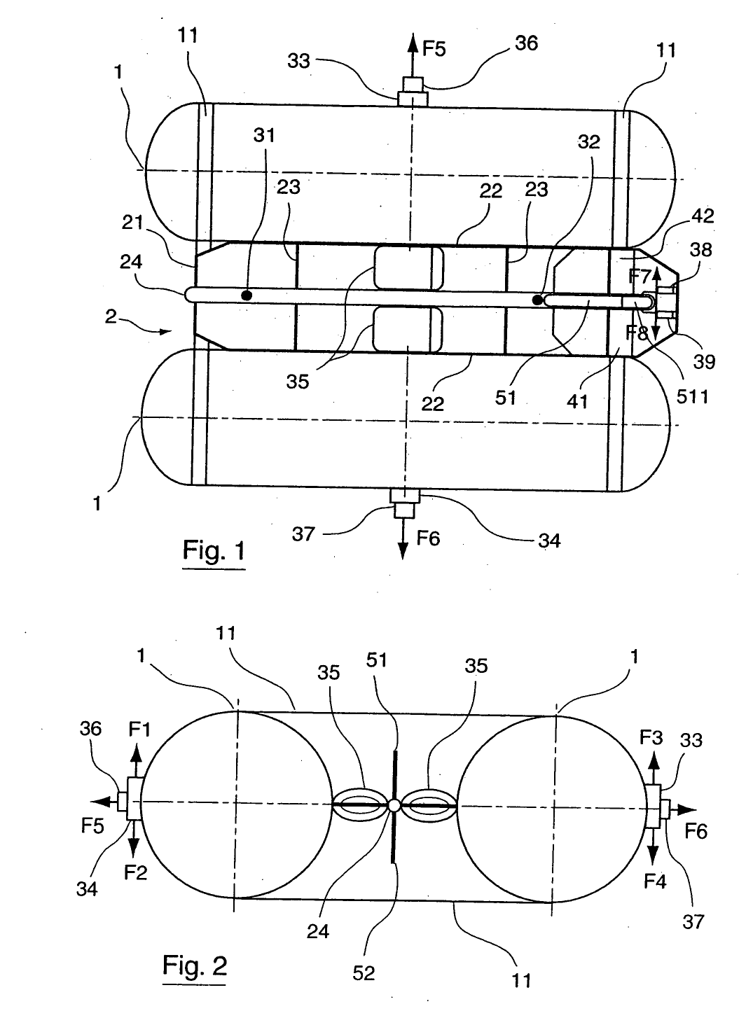

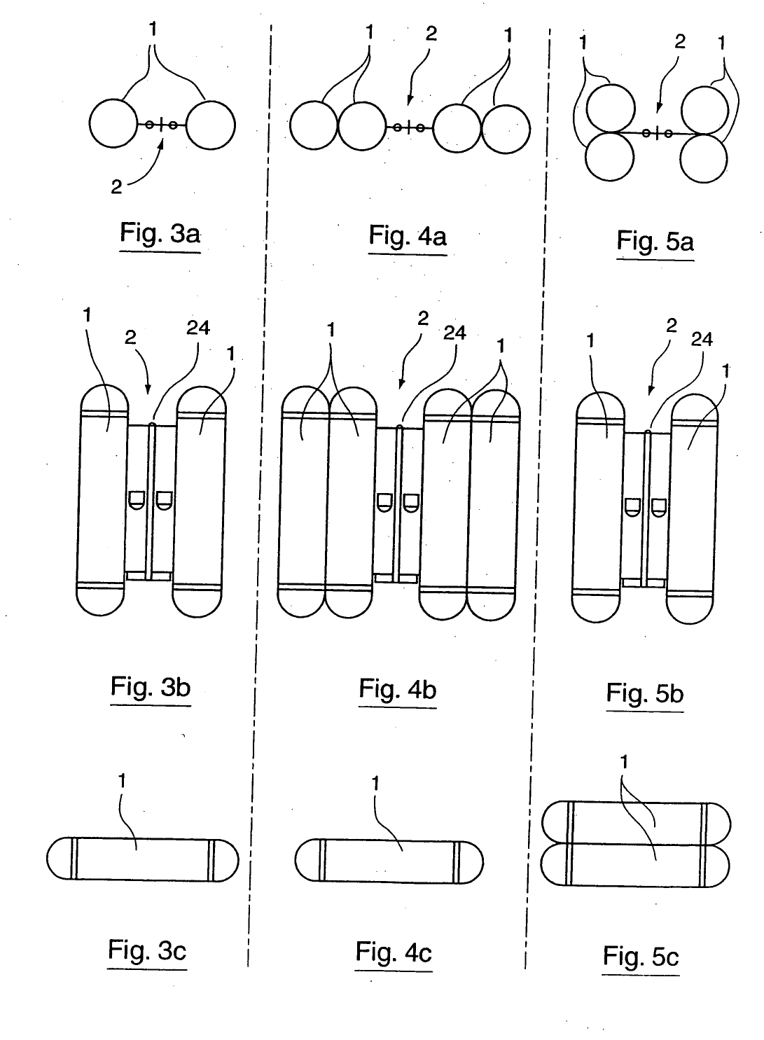

Other characteristics and advantages of the invention will become clearer after reading the following description of several variant embodiments of the invention given for illustrative and non-limitative purposes, and the attached drawings along which:
FIGS. 1 and 2 show top and front views of the aircraft according to the invention respectively;
FIGS. 3a, 3b and 3c show front, top and side views respectively of an aircraft according to the invention comprising two balloons;
FIGS. 4a, 4b and 4c show front, top and side views respectively of a variant embodiment of the invention according to which the aircraft comprises four balloons in an approximately horizontal plane;
FIGS. 5a, 5b and 5c show front, top and side views of a second variant embodiment of the invention according to which the aircraft comprises four balloons arranged in pairs, one above the other.

With reference to FIGS. 1 and 2, a lighter than air aircraft according to this embodiment of the invention comprises two cylindrical shaped balloons 1 connected to each other through a frame 2.

The chassis 2 comprises a frame 21 including longitudinal members 22 connected through stiffening cross pieces 23, a central cylinder 24 that will accommodate and/or support equipment being installed on the frame 21 of the chassis 2.

Each of the balloons 1 is installed free to pivot on the chassis about an axis approximately along the centre line of the longitudinal members 22.

It should be noted that according to another possible embodiment, the flexible assembly allowing the balloons to pivot with respect to the chassis can be made using an electromagnetic type link.

Elastic straps 11 connect the balloons 1, thus forming shock absorber means for any pivoting movements of the balloons 1 about the chassis 2.

The attitude (pitch and roll) control and the altitude control are achieved by a set of four engines 31, 32, 33 and 34 approximately in the same horizontal plane and designed to produce forces approximately perpendicular to this plane as illustrated by arrows F1 to F4 (for roll) in FIG. 2.

The pitch is controlled by engines 31 and 32 located on the longitudinal axis of the aircraft, on the forward and aft sides of the centre of gravity of the aircraft respectively.

A differential thrust on the engines 31 and 32 can vary the pitch of the aircraft, while identical thrusts and directions can make the aircraft go up or down.

Roll is controlled in a similar manner, this type using engines 34 and 35 installed in an approximately horizontal plane on each side of the longitudinal axis of the aircraft. More precisely, the engines 34 and 35 are installed along an axis perpendicular to the longitudinal axis of the aircraft passing approximately through the centre of gravity of the aircraft.

The position of the aircraft in the horizontal plane is controlled by a set of two propulsion systems approximately in the same horizontal plane and producing forces parallel to this plane.

A first of these two propulsion systems comprises engines 35 that produce a force parallel to the natural displacement axis of the aircraft. Thus, a thrust in the aft direction produced by the engines 35 moves the aircraft forwards; conversely, a forward thrust of these engines makes the aircraft backwards.

The second of the propulsion systems controlling the position of the aircraft in the horizontal plane is composed of the engines 36 and 37, capable of applying thrusts illustrated by arrows F5 and F6 respectively.

Thus, a thrust towards the right (arrow F5) produced by the engine 36 will move the aircraft towards the left, while a thrust towards the left (arrow F6) produced by the engine 37, will move the aircraft towards the right.

Obviously, the engines are connected to a control system capable of combining all movements induced by the thrust of engines 31, 32, 33, 34, 35, 36 and 37 or by the thrust of only some of the engines.

The aircraft orientation in the horizontal plane is controlled by engines 38 and 39.

According to another embodiment, the orientation of the aircraft can also be controlled by a single engine, for example an electric motor, installed so as to produce alternately opposing thrusts all by itself.

With engine 38, a thrust towards the right (arrow F7) will make the aircraft turn towards the right, while a thrust towards the left (arrow F8) by engine 39 will make the aircraft turn towards the left.

In addition to the propulsion systems that have just been described, the aircraft is equipped with a left control surface 41 and a right control surface 42 in this embodiment.

When these control surfaces 41 and 42 are inclined identically, they will move the aircraft up or down, while when their inclinations are approximately opposite, they will make the aircraft change direction.

The aircraft is also equipped with a vertical stabiliser composed of an upper vertical stabiliser 51 and a lower vertical stabiliser 52 (FIG. 2), each of which supports a control surface (the control surface 511 supported on vertical stabiliser 51 is shown in FIG. 1).

FIGS. 3a, 3b and 3c are diagrammatic views showing the top and side view of a first embodiment in which the aircraft comprises two balloons 1 connected to each other by connecting means 2, forming a symmetric assembly.

FIGS. 4a, 4b and 4c show diagrammatic top and side views respectively of a second embodiment according to which the aircraft comprises four balloons 1, distributed in pairs on each side of connecting means 2, two of the balloons 1 being connected to each other by connecting means 2. According to this embodiment, the four balloons 1 all lie in an approximately horizontal plane.

FIGS. 5a, 5b and 5c show diagrammatic top and side view respectively of a variant of the second embodiment according to which the aircraft comprises four balloons 1, distributed in pairs on each side of the connecting means 2 located one above the other.

It should be noted that regardless of which embodiment is used, the aircraft is designed such that:
the means that compose it form an approximately symmetric assembly;
the connecting means 2 on which the central cylinder 24 that will accommodate and/or support the equipment (and possibly any other means for accommodating one or several passengers) are installed, are essentially inscribed within the volume located between the balloons 1.

According to a first approach, the chassis 2 and/or the central cylinder 24 is designed to accommodate a pilot.

According to a second approach, the aircraft according to the invention is controlled by piloting from the ground by an operator or independently: piloting on the ground by an operator is done using a wired or wireless communication system, while independent piloting enables the aircraft to perform manoeuvres automatically by execution of downloaded plans, through wired or wireless communication systems.

It should be noted also that the aircraft can have different means onboard fixed to the chassis 2 and/or the central cylinder 24 by any appropriate means, enabling it to perform a large number of varied missions, these means consisting particularly of:
picture taking means;
sound pickup means;
meteorological data acquisition means;
radiation measurement means;
air analysis means;
geographic positioning means;
means of measuring the speed of objects on the ground and/or in the air and/or at sea.

1. Lighter than air aircraft characterised in that it comprises at least two balloons connected together by connecting means forming a chassis.

2. Aircraft according to claim 1, characterised in that the connecting means are connected to the balloons through an electromagnetic type connection.

3. Aircraft according to claim 1, characterised in that the connecting means are connected to at least one of the balloons through a mechanical connection articulated about at least one axis approximately parallel to the longitudinal axis of the aircraft.

4. Aircraft according to claim 1, characterised in that the balloon(s) on one side of the connecting means are connected to the balloon(s) on the other side of the connecting means by elastic means.

5. Aircraft according to claim 1, characterised in that the chassis includes carrying means designed to support equipment and or at least one person.

6. Aircraft according to claim 5, characterised in that the carrying means are essentially within the volume lying between the balloons.

7. Aircraft according to claim 1, characterised in that the balloons and the connecting means together form an essentially symmetric assembly.

8. Aircraft according to claim 1, characterised in that it comprises a balloon on each side of the connecting means.

9. Aircraft according to claim 1, characterised in that it comprises two balloons on each side of the connecting means.

10. Aircraft according to claim 9, characterised in that the balloons lie in an approximately horizontal plane.

11. Aircraft according to claim 9, characterised in that the two balloons on the same side of the connecting means are placed one above the other.

12. Aircraft according to claim 1, characterised in that the aircraft comprises means of propulsion and/or controlling the stability of the aircraft.

13. Aircraft according to claim 12, characterised in that the propulsion means comprise at least one first engine capable of producing a thrust along the longitudinal axis of the aircraft and located at or close to the centre of gravity of aircraft.

14. Aircraft according to claim 12, characterised in that it comprises pitch control means.

15. Aircraft according to claim 14, characterised in that the pitch control means include at least two engines installed approximately on the longitudinal axis of the aircraft, one forward from the centre of gravity of the aircraft, and the other aft from the centre of gravity of the aircraft.

16. Aircraft according to claim 11, characterised in that it comprises roll control means.

17. Aircraft according to claim 16, characterised in that the roll control means comprise at least two engines installed on each side of the longitudinal axis of the aircraft, in an approximately horizontal plane.

18. Aircraft according to claim 16, characterised in that the roll control means comprise roll control engines are mounted on an axis perpendicular to the longitudinal axis of the aircraft and passing through the centre of gravity of the aircraft or close to it.

19. Aircraft according to claim 1, characterised in that it comprises stability control means which can act on the altitude of the aircraft.

20. Aircraft according to claim 1, characterised in that it comprises propulsion means which further comprise a means of displacing the aircraft laterally.

21. Aircraft according to claim 20, characterised in that the lateral displacement means comprise at least two lateral engines capable of producing thrusts in opposite directions along a horizontal axis perpendicular to the longitudinal axis of the aircraft and passing through or close to the centre of gravity of the aircraft.

22. Aircraft according to claim 1, characterised in that it comprises directional means.

23. Aircraft according to claim 22, characterised in that the directional means comprise at least one control surface.

24. Aircraft according to claim 23, characterised in that it comprises at least one left control surface and at least one right control surface mounted at the aft of the aircraft.

25. Aircraft according to claim 1, characterised in that it comprises at least one vertical stabiliser.

26. Aircraft according to claim 25, characterised in that it comprises at least one control surface mounted on the vertical stabiliser.

27. Aircraft according to claim 22, characterised in that the directional means comprise at least one orientation engine installed so as to produce at least a thrust transverse to the longitudinal axis of the aircraft.

28. Aircraft according to claim 27, characterised in that the directional means comprise at least two orientation engines mounted with respect to each other so as to produce thrusts in approximately opposite directions.

29. Aircraft according to claim 1, characterised in that it comprises remote control means, with or without wire.

30. Aircraft according to any claim 1, characterised in that the balloons are approximately cylindrical in shape.

31. Aircraft according to claim 1, characterised in that it comprises onboard means belonging to the following group:
picture taking means,
communication and/or telecommunication means;
sound pickup means;
meteorological data acquisition means;
radiation measurement means;
air analysis means;
geographic positioning means;
means of measuring the speed of objects on the ground and/or in the air and/or at sea.
